(19) United States
(12) Patent Application Publication
(10) Pub. No.: US 2025/0321444 A1
(43) Pub. Date: Oct. 16, 2025

(54) LIGHT-EMITTING MODULE AND DISPLAY DEVICE

(71) Applicant: WUHAN CHINA STAR OPTOELECTRONICS TECHNOLOGY CO., LTD., Wuhan, Hubei (CN)

(72) Inventor: Wei CHENG, Wuhan, Hubei (CN)

(73) Assignee: WUHAN CHINA STAR OPTOELECTRONICS TECHNOLOGY CO., LTD., Wuhan, Hubei (CN)

(21) Appl. No.: 18/866,556

(22) PCT Filed: Mar. 31, 2023
(86) PCT No.: PCT/CN2023/085600

§ 371 Date: Nov. 17, 2024

(30) Foreign Application Priority Data
Aug. 31, 2022 (CN) 202211055622.5

(51) Int. Cl. G02F 1/1334; G02F 1/13; G02F 1/1335; G02F 1/1337; G02F 1/1343

(52) U.S. Cl. CPC G02F 1/13345; G02F 1/1323; G02F 1/133531; G02F 1/133607; G02F 1/133769; G02F 1/134309

(57) ABSTRACT

A light-emitting module and a display device are provided. The light-emitting module includes a light-emitting plate and a first light-adjusting plate, and the first light-adjusting plate is located on a light-exiting side of the light-emitting plate. The first light-adjusting plate includes: a first polymer liquid crystal layer including polymer networks and liquid crystal molecules dispersed in the polymer networks; and a first electrode layer and a second electrode layer disposed oppositely on two sides of the first polymer liquid crystal layer. The first electrode layer includes at least two first electrodes spaced apart.

### TECHNICAL FIELD

The present application relates to the field of display technologies, and more particularly, to a light-emitting module and a display device.

### BACKGROUND

As the technology advances and the consumptive electronic product iterates, users are also increasingly concerned about privacy protection issues. Currently, the existing anti-peeping display technology is to perform anti-peeping processing on an entire display screen of a display panel. However, a full-screen anti-peeping screen has a controlled relatively low degree of flexibility when being used by the user. In particular, for a long screen with a large size, since the long screen has only full-screen anti-peeping function, the full-screen anti-peeping screen cannot realize such a function that two partial regions of the display screen need to separately perform anti-peep and sharing.

Therefore, in most vehicle enterprises, a three-screen or a two-screen is used, that is, a plurality of individual screens are adhered on the same cover plate, and a secondary screen which needs to be prevented from peeping is treated separately. However, this method makes a visible boundary occurs between the screen and the adjacent screen, which affects a user's viewing experience.

Accordingly, there is a problem in the prior art that the partial anti-peep and the integral display are not compatible.

### SUMMARY

### Technical Problem

The present application provides a light-emitting module which enables a partial anti-peep and a integral display to be compatible, so that a display device has a partial anti-peeping effect while performing the integral display.

### Technical Solution

The present application provides a light-emitting module including a light-emitting plate and a first light-adjusting plate, the first light-adjusting plate being located on a light-exiting side of the light-emitting plate; in which the first light-adjusting plate includes:
a first polymer liquid crystal layer including polymer networks and liquid crystal molecules dispersed in the polymer networks; and
a first electrode layer and a second electrode layer disposed oppositely on two sides of the first polymer liquid crystal layer, in which the first electrode layer includes at least two first electrodes spaced apart.

Optionally, in some embodiments of the present application, the second electrode layer includes at least two second electrodes spaced apart, the at least two second electrodes and the at least two first electrodes are arranged in one-to-one correspondence, and each of the at least two second electrodes is disposed oppositely to a corresponding one of the at least two first electrodes.

Optionally, in some embodiments of the present application, the first light-adjusting plate further includes a first polarizer and a second polarizer oppositely disposed, the first polarizer is provided on a side of the first electrode layer facing away from the first polymer liquid crystal layer, and the second polarizer is provided on a side of the second electrode layer facing away from the first polymer liquid crystal layer;

an optical axis direction of the first polarizer is parallel to an optical axis direction of the second polarizer; the polymer networks are extended in a first direction inclined with respect to a normal direction of the first polarizer.

Optionally, in some embodiments of the present application, the first light-adjusting plate further includes a first alignment layer and a second alignment layer disposed oppositely on the two sides of the first polymer liquid crystal layer, the first alignment layer is disposed between the first electrode layer and the first polymer liquid crystal layer, and the second alignment layer is disposed between the second electrode layer and the first polymer liquid crystal layer; the first alignment layer and the second alignment layer each form an inclined orientation in which a pre-inclined direction is parallel to the first direction.

Optionally, in some embodiments of the present application, the light-emitting module further includes a light-intensifying plate provided between the light-emitting plate and the first light-adjusting plate, and the light-intensifying plate includes a sidewise light guide plate and a light-intensifying source located on a side wall of the sidewise light guide plate.

Optionally, in some embodiments of the present application, the light-emitting plate includes a vertical light guide plate, and a lattice point density of the sidewise light guide plate is smaller than a lattice point density of the vertical light guide plate.

Optionally, in some embodiments of the present application, the light-emitting module further includes an anti-peeping film provided between the light-emitting plate and the first light-adjusting plate, and the light-intensifying plate is provided between the anti-peeping film and the first light-adjusting plate.

Optionally, in some embodiments of the present application, an anti-peeping angle of the anti-peeping film is from 40 degrees to 60 degrees.

Optionally, in some embodiments of the present application, the light-emitting module further includes an anti-peeping film provided between the light-emitting plate and the first light-adjusting plate.

Optionally, in some embodiments of the present application, the light-emitting module further includes a second light-adjusting plate located between the light-emitting plate and the anti-peeping film; the second light-adjusting plate includes:
a second polymer liquid crystal layer including polymer networks and liquid crystal molecules dispersed in the polymer networks; and
a third electrode layer and a fourth electrode layer disposed oppositely on two sides of the second polymer liquid crystal layer, the third electrode layer includes at least two third electrodes spaced apart; and the at least two third electrodes and the at least two first electrodes are arranged in one-to-one correspondence.

Optionally, in some embodiments of the present application, the fourth electrode layer includes at least two fourth electrodes spaced apart, the at least two fourth electrodes and the at least two third electrodes are arranged in one-to-one correspondence, and each of the at least two fourth electrodes and a corresponding one of the at least two third electrodes are oppositely disposed.

Optionally, in some embodiments of the present application, the light-emitting module includes a first region and a second region, the first region corresponds to one of the at least two third electrodes, and the second region corresponds to an other one of the at least two third electrodes; when the first region is in an anti-peeping state and the second region is in a sharing state, the first light-adjusting plate in the first region is in a transparent state, the second light-adjusting plate in the first region is in a fog state, the first light-adjusting plate in the second region is in the fog state, and the second light-adjusting plate in the second region is in the transparent state.

Optionally, in some embodiments of the present application, the anti-peeping film and the first light-adjusting plate are adhered by a first optical adhesive layer having a refractive index lower than a refractive index of the first light-adjusting plate.

Optionally, in some embodiments of the present application, the refractive index of the first optical adhesive layer is less than 1.2.

Further, the application also provides a display device including the light-emitting module described in any one of embodiments.

### BENEFICIAL EFFECT

Compared with the prior art,

The present application provides a light-emitting module and a display device, in which a light-adjusting cell or a driving electrode in a light-adjusting film in the light-emitting module is arranged at a partition interval, so that the light-emitting module integrally emits light and is compatible with partial anti-peep.

### BRIEF DESCRIPTION OF THE DRAWINGS

FIG. 1 is a schematic diagram showing a first structure of a light-emitting module according to an embodiment of the present application;

FIG. 2 is a schematic plan diagram of a first electrode layer of a light-emitting module according to an embodiment of the present application;

FIG. 3 is a schematic diagram showing two operating states of the light-emitting module with the first structure;

FIG. 4 is a schematic diagram showing a second structure of a light-emitting module according to an embodiment of the present application;

FIG. 5 is a schematic diagram showing a structure and a principle of a light-intensifying plate of a light-emitting module according to an embodiment of the present application;

FIG. 6 is a schematic diagram showing two operating states of the light-emitting module with the second structure;

FIG. 7 is a schematic diagram showing a third structure of a light-emitting module according to an embodiment of the present application;

FIG. 8 is a schematic diagram showing a fourth structure of a light-emitting module according to an embodiment of the present application;

FIG. 9 is a schematic diagram showing a fifth structure of a light-emitting module according to an embodiment of the present application;

FIG. 10 is a schematic diagram showing two operating states of the light-emitting module with the fifth structure;

FIG. 11 is a schematic diagram showing a sixth structure of a light-emitting module according to an embodiment of the present application; and

FIG. 12 is a schematic diagram showing two operating states of the light-emitting module with the sixth structure.

### DETAILED DESCRIPTION

In order that the objects, technical solutions, and effects of the present application may be made clearer and more definite, the present application will be described in further detail below with reference to the accompanying drawings, which is illustrated by way of examples only. It is to be understood that the specific embodiments described herein are merely illustrative of the present application and are not intended to limit the present application.

The present application provides a light-emitting module that may solve the problem that a conventional display device is incompatible with the partial anti-peep and the integral display.

A light-emitting module provided in an embodiment of the present application includes a light-emitting plate and a first light-adjusting plate. The first light-adjusting plate is located on a light-exiting side of the light-emitting plate. The first light-adjusting plate includes:
a first polymer liquid crystal layer including polymer networks and liquid crystal molecules dispersed in the polymer networks; and
a first electrode layer and a second electrode layer disposed oppositely on two sides of the first polymer liquid crystal layer, in which the first electrode layer includes at least two first electrodes spaced apart.

According to the light-emitting module provided in the embodiment of the present application, the first electrode layer of the first light-adjusting plate is provided as at least two independent first electrodes spaced apart, and an input voltage of each of the first electrodes is respectively controlled, so that electric fields between the first electrode and the second electrode layer and between the other first electrode and the second electrode layer are respectively regulated, thereby independently regulating an anti-peeping state or a sharing state of the light-emitting module in a region in which each of the first electrodes is located, and achieving good compatibility of the integral luminescence and the partial anti-peep of the light-emitting module.

Hereinafter, a light-emitting module provided in accordance with an embodiment of the present application will be described in detail with reference to the accompanying drawings.

### Example 1

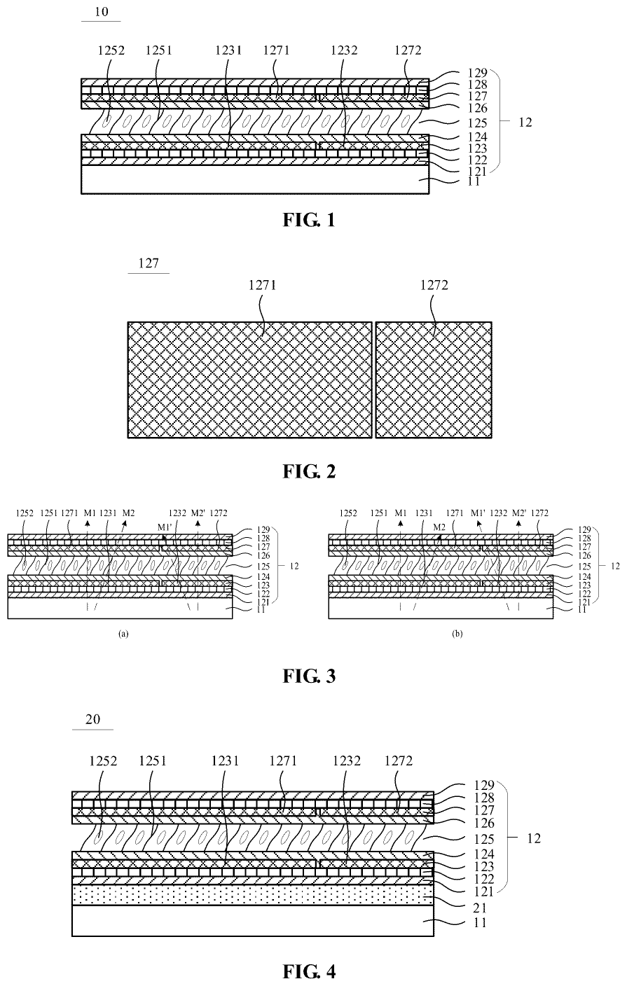

Referring to FIG. 1, FIG. 1 is a schematic diagram showing a first structure of a light-emitting module according to an embodiment of the present application. In the present embodiment, the first light-adjusting plate is a light-adjusting cell 12. The light-emitting module 10 provided in the present embodiment includes a light-emitting plate 11 and the light-adjusting cell 12. The light-adjusting cell 12 is located on a light-exiting side of the light-emitting plate 11. The light-adjusting cell 12 includes:
a first polarizer 121 and a second polarizer 129 oppositely disposed, in which the first polarizer 121 is disposed between the light-emitting plate 11 and the second polarizer 129; an optical axis direction of the first polarizer 121 is parallel to an optical axis direction of the second polarizer 129; and
a first substrate 122 and a second substrate 128 oppositely disposed, in which the first substrate 122 is disposed on a side of the first polarizer 121 facing away from the light-emitting plate 11, and the second substrate 128 is disposed on a side of the second polarizer 129 facing toward the first polarizer 121, the first substrate 122 is disposed between the first polarizer 121 and the second substrate 128; the first substrate 122 and the second substrate 128 are transparent substrates, and may be transparent organic substrates, such as polyethylene terephthalate (referred briefly to as PET) substrates, or transparent inorganic substrates, such as glass;
a first electrode layer 123 and a second electrode layer 127 oppositely disposed, in which the first electrode layer 123 is provided on a side of the first substrate 122 facing away from the first polarizer 121, and the second electrode layer 127 is provided on a side of the second substrate 128 facing toward the first substrate 122; the second electrode layer 127 is provided between the first electrode layer 123 and the second substrate 128; the first electrode layer 123 includes at least two first electrodes 1231/1232 spaced apart, and/or the second electrode layer 127 includes at least two second electrodes 1271/1272 spaced apart;
a first alignment layer 124 and a second alignment layer 126 oppositely disposed, in which the first alignment layer 124 is disposed on one side of the first electrode layer 123 adjacent to the second electrode layer 127, and the second alignment layer 126 is disposed on one side of the second electrode layer 127 adjacent to the first electrode layer 123; the second alignment layer 126 is disposed between the first alignment layer 124 and the second electrode layer 127; the first alignment layer 124 and the second alignment layer 126 each form an inclined orientation in which a pre-inclined direction thereof is parallel to a first direction, and the first direction is inclined with respect to a normal direction of the first polarizer 121; and
a polymer liquid crystal layer 125 disposed between the first alignment layer 124 and the second alignment layer 126, in which the polymer liquid crystal layer 125 includes polymer networks 1251 and liquid crystal molecules 1252 dispersed in the polymer networks 1251; the polymer networks 1251 are extended in the first direction, and the liquid crystal molecules form a pre-inclined arrangement in the first direction.

In the light-adjusting cell 12 provided in an embodiment of the present application, the first electrode layer 123 and the second electrode layer 127 are used to load a voltage to control the deflection of the liquid crystal molecules 1252. Specifically, when the voltage difference between the first electrode layer 123 and the second electrode layer 127 is less than a threshold value, the long axes of the liquid crystal molecules 1252 are extended in the first direction. In this way, the light rays M1/M1′ incident in a normal direction of the first polarizer 121 exits the light-adjusting cell 12 through the second polarizer 129, and the light rays M2/M2′ incident in a direction of inclining to the normal direction the first polarizer 121 is blocked or partially blocked by the second polarizer 129. So, the light rays of the light-emitting module 10 which are at the side viewing angle are decreased, and thus the light-emitting module 10 is in an anti-peeping state. When the voltage difference between the first electrode layer 123 and the second electrode layer 127 is greater than the threshold value, the long axes of the liquid crystal molecules 1252 are extended in a second direction, which is different from the first direction. In this way, the light rays M2/M2′ incident in the direction of inclining to the normal direction of the first polarizer 121 may more exit from the light-adjusting cell 12 through the second polarizer 129. So, the light rays of the light-emitting module 10 which are at the side viewing angle are increased, and the light-emitting module 10 is in a sharing state. The threshold value is determined according to the parameter properties of the polymer networks 1251 and the liquid crystal molecules 1252 in the polymer liquid crystal layer 125, and the like, and may be specifically set according to actual conditions, which is not limited herein.

In a first embodiment, as shown in FIG. 2, FIG. 2 is a schematic plan diagram of the first electrode layer in FIG. 1. The first electrode layer 123 includes two first electrodes, i.e., a first electrode 1231 and a first electrode 1232, respectively. The second electrode layer 127 is integrally formed in an manner of an entire surface. Thus, by regulating and controlling the voltage input of the first electrodes 1231, 1232 and the voltage input of the second electrode layer 127, the electric field between the first electrode 1231 and the second electrode layer 127, and the electric field between the first electrode 1232 and the second electrode layer 127 may be regulated, respectively, so that it may regulate the anti-peeping state or the sharing state of the light-emitting module 10 in the region where the first electrode 1231 is located and the anti-peeping state or the sharing state of the light-emitting module 10 in the region where the first electrode 1232 is located, respectively.

Specifically, referring to FIG. 3, FIG. 3 is a schematic diagram showing two operation states of the light-emitting module 10 with the first structure. When the light-emitting module 10 in the region in which the first electrode 1231 is located needs to be in the anti-peeping state, and the light-emitting module 10 in the region in which the first electrode 1232 is located needs to be in the sharing state, the input voltages of the first electrode 1231 and the first electrode 1232 are adjusted so that the voltage difference between the first electrode 1231 and the second electrode layer 127 is smaller than the threshold value, and the voltage difference between the first electrode 1232 and the second electrode layer 127 is larger than the threshold value, as shown in (b) of FIG. 3. When the light-emitting module 10 in the region in which the first electrode 1231 is located needs to be in the sharing state, and the light-emitting module 10 in the region in which the first electrode 1232 is located needs to be in the anti-peeping state, the input voltages of the first electrode 1231 and the first electrode 1232 are adjusted so that the voltage difference between the first electrode 1231 and the second electrode layer 127 is larger than the threshold value, and the voltage difference between the first electrode 1232 and the second electrode layer 127 is smaller than the threshold value, as shown in (a) of FIG. 3. When both the light-emitting module 10 in the region where the first electrode 1231 is located and the light-emitting module 10 in the region where the first electrode 1232 is located need to be in the anti-peeping state, the voltage difference between the first electrode 1231 and the second electrode layer 127 and the voltage difference between the first electrode 1232 and the second electrode layer 127 are made smaller than the threshold value. When both the light-emitting module 10 in the region where the first electrode 1231 is located and the light-emitting module 10 in the region where the first electrode 1232 is located need to be in the sharing state, the voltage difference between the first electrode 1231 and the second electrode layer 127 and the voltage difference between the first electrode 1232 and the second electrode layer 127 are made larger than the threshold value.

According to the present embodiments, the first electrode layer 123 in the light-adjusting cell 12 is provided as two independent first electrodes spaced apart, and a voltage difference between each first electrode and the second electrode layer 127 is controlled by controlling an input voltage of this first electrode separately, thereby independently adjusting the anti-peeping state or the sharing state of the light-emitting module in the region in which each of the first electrodes is located, and further achieving good compatibility of integral light emitting and partial anti-peep of the light-emitting module 10.

The first electrode layer 123 may be provided as a left first electrode and a right first electrode as shown in FIG. 2, or three or more first electrodes that are separately spaced apart and arranged in sequence as required, or may be provided as a plurality of matrix-type first electrodes, a plurality of surrounding first electrodes, or the like. Specifically, the first electrode layer may be designed according to the setting of the anti-peeping region, which is not limited herein as long as that the design scheme that the light-emitting module integrally emits light and partially prevents peeping by using the first electrodes spaced apart is satisfied.

In the second embodiment, the second electrode layer 127 includes two second electrodes, i.e., a second electrode 1271 and a second electrode 1272, respectively. The first electrode layer 123 is integrally formed in a manner of the entire surface. The second electrode layer 127 is arranged in a manner similar to that of the first electrode layer 123 in the first embodiment. The operation principle of the light-adjusting cell in the present embodiment is the same as that of the light-adjusting cell in the first embodiment, and for details, the first embodiment may be referred to.

In a third embodiment, as shown in FIG. 1, the first electrode layer 123 includes two first electrodes, i.e., the first electrode 1231 and the first electrode 1232, respectively. The second electrode layer 127 includes two second electrodes, i.e., a second electrode 1271 and a second electrode 1272, respectively. The first electrode 1231 and the second electrode 1271 are oppositely disposed. A projection of the second electrode 1271 on the first electrode layer 123 coincides with the first electrode 1231. The first electrode 1232 and the second electrode 1272 are oppositely disposed. A projection of the second electrode 1272 on the first electrode layer 123 coincides with the first electrode 1232. Parts of the present embodiment which are the same as or similar to those of the first embodiment and the second embodiment are not described in detail, except that both the first electrode 1231 and the second electrode 1271 together control the anti-peeping state or the sharing state of the light-emitting module 10 in the region where the first electrode 1231 is located, and both the first electrode 1232 and the second electrode 1272 together control the anti-peeping state or the sharing state of the light-emitting module 10 in the region where the first electrode 1232 is located. Thus, when the light-emitting module 10 in the region in which the first electrode 1231 is located is in the anti-peeping state, and the light-emitting module 10 in the region in which the first electrode 1232 is located is in the sharing state, it is only necessary to input a respective voltage signal to both the first electrode 1232 and the second electrode 1272, so that the voltage difference between the first electrode 1232 and the second electrode 1272 is larger than the threshold value. Compared with the above two embodiments, power consumption is reduced, and at the same time, the existence of a boundary electric field between the first electrode layer 123 integrally formed in an entire surface manner and the second electrode 1272 or the existence of a boundary electric field between the second electrode layer 127 integrally formed in an entire surface manner and the first electrode 1232 is avoided, thereby improving control accuracy. The first electrode layer 123 and the second electrode layer 127 are designed in a manner similar to the first embodiment, and for details, the first embodiment may be referred to.

### Example 2

Referring to FIG. 4, FIG. 4 is a schematic diagram showing a second structural of a light-emitting module according to an embodiment of the present application. The light-emitting module 20 according to the first embodiment further includes a light-intensifying plate 21 provided between the light-emitting plate 11 and the light-adjusting cell 12. Referring to FIG. 5, FIG. 5 is a schematic diagram showing a structure and a principle of the light-intensifying plate 21. The light-intensifying plate 21 includes a sidewise light guide plate 211 and a light-intensifying source 212 located on a side wall of the sidewise light guide plate 211. Light emitted from the light-intensifying source 212 enters the sidewise light guide plate 211 from a side direction, propagates through the guide of the sidewise light guide plate 211, and exits the sidewise light guide plate 211 obliquely in a direction away from the light-intensifying source 212, as shown by the light rays P1 and P2 in FIG. 5.

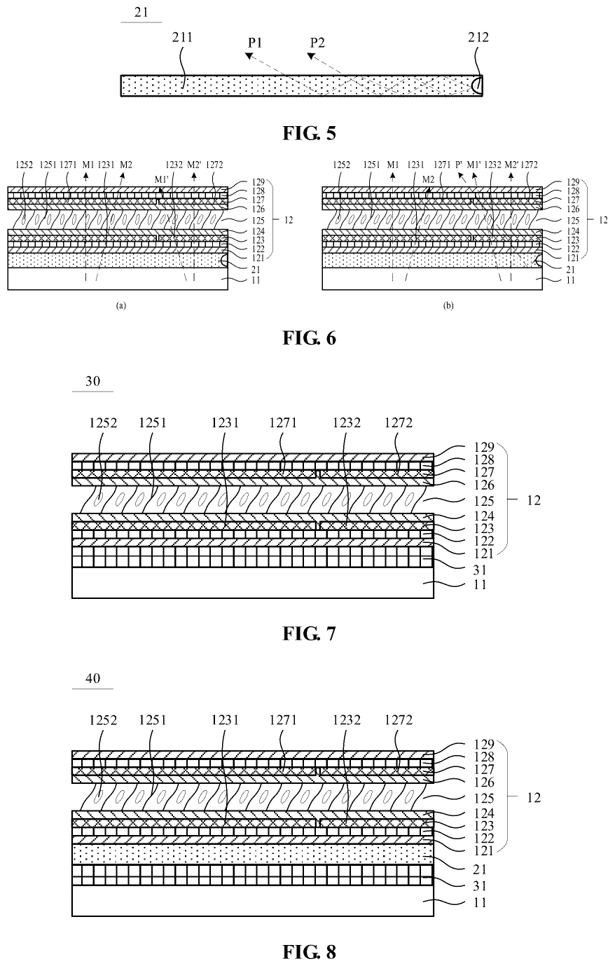

As shown in FIG. 6, FIG. 6 is a schematic diagram showing two operation states of the light-emitting module 20 with the second structure. The light-intensifying source 212 is provided on a side of the sidewise light guide plate 211 which is close to the first electrode 1232. In this case, when the light-emitting module 20 in the region in which the first electrode 1232 is located is in the anti-peeping state, the light-intensifying source 212 is in a turn-off state, and the light-intensifying plate 21 serves as a transparent substrate through which light emitted from the light-emitting plate 11 passes, as shown in (a) of FIG. 6. And, when the light-emitting module 20 in the region in which the first electrode 1232 is located is in the sharing state, the light-intensifying source 212 is turned on, and the light ray P′ emitted from the light-intensifying source 212 is guided and propagated through the sidewise light guide plate 211, and then exits from the sidewise light guide plate 211 in the direction away from the light-intensifying source 212 and deviating from the normal direction of the first polarizer 121. So, the intensity of the light rays, which are at the side viewing angle away from the light-intensifying source 212, of the light-emitting module 20 in the region where the first electrode 1232 is located is increased, thereby improving the sharing effect of the light-emitting module 20 in the region where the first electrode 1232 is located, as shown in (b) of FIG. 6. Similarly, by arranging the light-intensifying source 212 on a side of the sidewise light guide plate 211 which is close to the first electrode 1232, the sharing effect of the light-emitting module 20 in the region where the first electrode 1231 is located may be improved.

Therefore, the specific arrangement position of the light-intensifying source 212 and the specific structure of the sidewise light guide plate 211 may be specifically designed according to regional anti-peeping and sharing requirements of the light-emitting module 20. For example, when the light-emitting module 20 in the region in which the first electrode 1232 is located is in the sharing state, the light-intensifying source 212 is provided on the side wall of the sidewise light guide plate 211 which is adjacent to the first electrode 1232, and the light-exiting direction of the light-intensifying source 212 coincides with the sharing direction of the light-emitting module 20 in the region in which the first electrode 1232 is located. When the light-emitting module 20 in the region in which the first electrode 1231 is located is in the sharing state, the light-intensifying source 212 is provided on the side wall of the sidewise light guide plate 211 which is adjacent to the first electrode 1231, and the light-exiting direction of the light-intensifying source 212 coincides with the sharing direction of the light-emitting module 20 in the region in which the first electrode 1231 is located. When the light-emitting module 20 in the region in which the first electrode 1231 is located and the light-emitting module 20 in the region in which the first electrode 1232 is located are each in the sharing state, the light-intensifying sources 212 may be provided on each of the side wall of the sidewise light guide plate 211 which is close to the first electrode 1232 and the side wall of the sidewise light guide plate 211 which is close to the first electrode 1231. And, it may enhance the sharing effects of the partial regions respectively, by the specific material and the specific lattice point design of the sidewise light guide plate 211. The light-intensifying plate 21 may be integrally formed in an entire surface, and corresponding lattice points are provided for the sidewise light guide plate 211 in the partial region. It is also possible to partially set for the region in which the sharing effect needs to be enhanced. A plurality of the light-intensifying plates 21 may be provided separately, and each of the light-intensifying plates 21 corresponds to one or more regions in which the sharing effect needs to be enhanced.

### Example 3

Referring to FIG. 7, FIG. 7 is a schematic diagram showing a third structural of a light-emitting module according to an embodiment of the present application. The light-emitting module 30 according to the present embodiment further includes an anti-peeping film 31 provided between the light-emitting plate 11 and the light-adjusting cell 12, based on the light-emitting module 10 according to the first embodiment. The anti-peeping film 31 initially converges the light emitted from the light-emitting plate 11. When an anti-peeping angle of the light-adjusting cell 12 is the same as a convergence direction of the anti-peeping film 31, the light-adjusting cell 12 further narrows the anti-peeping angle, and the light-adjusting cell 12 and the anti-peeping film 31 cooperate to further improve the anti-peeping effect of the light-emitting module 30.

The anti-peeping film 31 may be provided to be single-side anti-peep, double-side anti-peep, or multi-side anti-peep according to specific regional anti-peeping requirements of the light-emitting module 30. The anti-peeping angle of the anti-peeping film 31 is from 40 degrees to 60 degrees, so that the intensity of the light in the viewing angle direction of ranging from 30 degrees to 45 degrees is less than 1%, so as to satisfy the user's anti-peeping requirement of ranging from 30 degrees to 45 degrees. Preferably, the anti-peeping angle of the anti-peeping film 31 is from 48 degrees or 60 degrees.

When the light-emitting module 30 is applied to the on-board display, the light-emitting module 30 provides a light source for both the left-hand driving position and the right-hand auxiliary driving position. During driving, for safety reasons, the amusement screen for the co-driver needs to be switched to the left anti-peeping mode to avoid disturbing the driver. The anti-peeping film 31 may be provided to be a single left-side anti-peep, a single front-side anti-peep, a left and right dual-side anti-peep, a front and back dual-side anti-peep, a front, back, left and right four-side anti-peep. The left-side anti-peep may prevent light from directly entering the eyes of the driver to cause interference to the driver. The front-side anti-peep prevents light from being incident on the front windshield of the vehicle and reflecting to the eyes of the driver to interfere with the driver's vision. The light-adjusting cell 12 may also be provided to be a left and right anti-peep or a front and rear anti-peep. When the anti-peeping film 31 is provided as the single left-side anti-peep, the left and right dual-side anti-peep, or the left, right, front and back four-side anti-peep, and the light-adjusting cell 12 is provided as the left and right anti-peep, the anti-peeping film 31 and the light-adjusting cell 12 are cooperated together to improve the left-side anti-peeping effect of the light-emitting module 30 and even the on-board display. When the anti-peeping film 31 is provided as a single left-side anti-peeping film, a left and right dual-side anti-peeping film, or a left, right, front and back four-side anti-peeping film, and the light-adjusting cell 12 is provided to be front and back anti-peep, the anti-peeping film 31 is used to realize the left anti-peeping effect of the light-emitting module 30 and even the on-board display. The anti-peeping film 12 is used to prevent light from being incident on the front windshield of the vehicle.

### Example 4

Referring to FIG. 8, FIG. 8 is a schematic diagram showing a fourth structure of a light-emitting module according to an embodiment of the present application. The light-emitting module 40 according to the present embodiment further includes the light-intensifying plate 21 and the anti-peeping film 31, based on the light-emitting module 10 according to the first embodiment. The anti-peeping film 31 is provided between the light-emitting plate 11 and the light-intensifying plate 21. The light-intensifying plate 21 is provided between the anti-peeping film 31 and the light-adjusting cell 12.

### Example 5

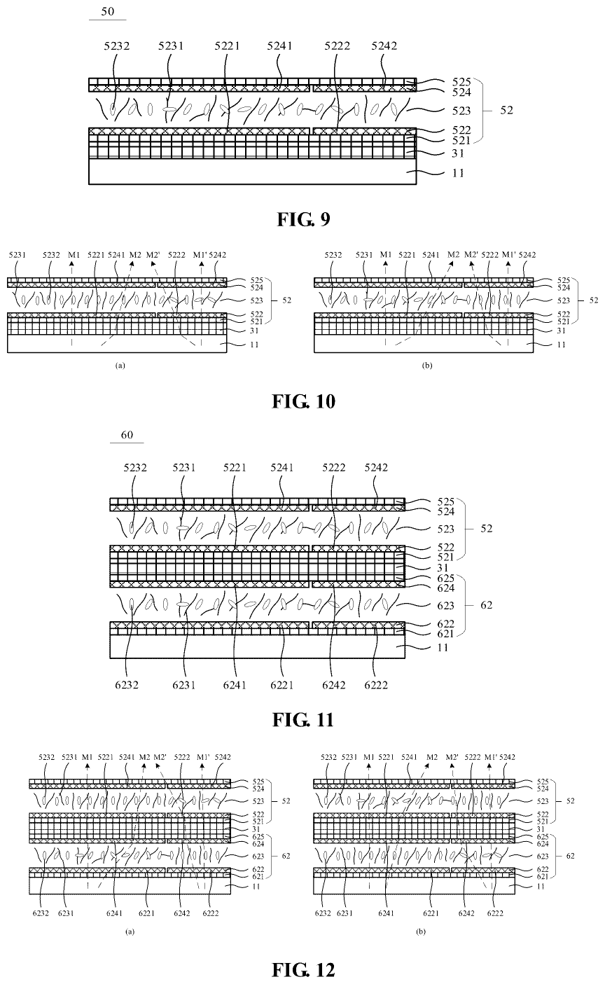

Referring to FIG. 9, FIG. 9 is a schematic diagram showing a fifth structure of a light-emitting module according to an embodiment of the present application. In the present embodiment, the first light-adjusting plate is a first light-adjusting film 52. A light-emitting module 50 provided in the present embodiment includes a light-emitting plate 11, an anti-peeping film 31, and a first light-adjusting film 52. The anti-peeping film 31 is provided on the light-exiting side of the light-emitting plate 11 and between the light-emitting plate 11 and the first light-adjusting film 52. The first light-adjusting film 52 includes:
a first polymer liquid crystal layer 523 including polymer networks 5231 and liquid crystal molecules 5232 dispersed in the polymer networks;
a first substrate 521 and a second substrate 525 oppositely disposed on two sides of the first polymer liquid crystal layer 523, in which materials of the first substrate 521 and the second substrate 525 are generally polyethylene terephthalate or polycarbonate;
a third electrode layer 522 and a fourth electrode layer 524 oppositely disposed, in which the third electrode layer 522 is disposed between the first substrate 521 and the first polymer liquid crystal layer 523; and the fourth electrode layer 524 is disposed between the second substrate 525 and the first polymer liquid crystal layer 523;
in which the third electrode layer 522 includes at least two third electrodes 5221/5222 spaced apart, and/or the fourth electrode layer 524 includes at least two fourth electrodes 5241/5242 spaced apart.

The arrangement manner and the operation principle of the third electrode layer 522 and the fourth electrode layer 524 are similar to those of the first electrode layer 123 and the second electrode layer 127 in Example 1. Specifically, for details, reference is made to Example 1.

Referring to FIG. 10, FIG. 10 is a schematic diagram showing two operation states of a light-emitting module 50 with a fifth structure. The third electrode layer 522 includes third electrodes 5221 and 5222, and the fourth electrode layer 524 includes fourth electrodes 5241 and 5242. The operation principle of the light-emitting module 50 according to the present embodiment is explained as follows. Light rays M1/M1′/M2/M2′ emitted by the light-emitting plate 11 are converged after passing through the anti-peeping film 31. When the light-emitting module 50 in the region in which the third electrode 5222 is located is in the anti-peeping state, and the light-emitting module 50 in the region in which the third electrode 5221 is located is in the sharing state, there is no electric field between the third electrode 5221 and the fourth electrode 5241, and the liquid crystal molecules 5232 are arranged in an unordered manner. The first light-emitting film 52 in the region in which the third electrode 5221 is located is in a fog state, and is used to disperse light converged by the anti-peeping film 31. In this way, the light-emitting module 50 in the region in which the third electrode 5221 is located is in the sharing state, an ordered electric field is formed between the third electrode 5222 and the fourth electrode 5242, and the liquid crystal molecules 5232 are arranged in an ordered manner. The first light-emitting film 52 in the region in which the third electrode 5222 is located is in a transparent state, and thus light converged by the anti-peeping film 31 is directly transmitted, so that the light-emitting module 50 in the region in which the third electrode 5222 is located is in the anti-peeping state, as shown in (b) of FIG. 10. When the light-emitting module 50 in the region in which the third electrode 5221 is located is in the anti-peeping state and the light-emitting module 50 in the region in which the third electrode 5222 is located is in the sharing state, the operation principle of the light-emitting module 50 is contrary, as shown in (a) of FIG. 10.

The anti-peeping film 31 and the first light-adjusting film 52 are adhered by a first optical adhesive layer (not shown). A refractive index of the first optical adhesive layer is lower than a refractive index of the first light-adjusting film 52. The refractive index of the first optical adhesive layer is less than 1.2. In this way, light incident on the first light-adjusting film 52 may be further converged, thereby improving the anti-peeping effect of the light-emitting module 50.

### Example 6

Referring to FIG. 11, FIG. 11 is a schematic diagram showing a light-emitting module with a sixth structure according to an embodiment of the present application. The light-emitting module 60 according to the present embodiment further includes, on the basis of the light-emitting module 50 according to the fifth embodiment, a second light-adjusting film 62. The second light-adjusting film 62 is provided between the light-emitting plate 11 and the anti-peeping film 31. The second light-adjusting film 62 includes:
a second polymer liquid crystal layer 623 including polymer networks 6231 and liquid crystal molecules 6232 dispersed in the polymer networks;
a third substrate 621 and a fourth substrate 625 oppositely disposed, in which materials of the third substrate 621 and the fourth substrate 625 are generally polyethylene terephthalate or polycarbonate;
a fifth electrode layer 622 and a sixth electrode layer 624 oppositely disposed, in which the fifth electrode layer 622 is disposed between the third substrate 621 and the second polymer liquid crystal layer 623, and the sixth electrode layer 624 is disposed between the fourth substrate 625 and the second polymer liquid crystal layer 623;
in which the fifth electrode layer 622 includes at least two fifth electrodes 6221/6222 spaced apart, and/or the sixth electrode layer 624 includes at least two sixth electrodes 6241/6242 spaced apart.

The arrangement manner and the operation principle of the fifth electrode layer 622 and the sixth electrode layer 624 are similar to that of the third electrode layer 522 and the fourth electrode layer 524 in Example 5. Specifically, for details, reference is made to Example 5.

Referring to FIG. 12, FIG. 12 is a schematic diagram showing two operation states of the light-emitting module 60 with the sixth structure. The third electrode layer 522 includes third electrodes 5221 and 5222. The fourth electrode layer 524 includes fourth electrodes 5241 and 5242. The fifth electrode layer 622 includes fifth electrodes 6221 and 6222. The sixth electrode layer 624 includes sixth electrode 6241 and 6242. The operation principle of the light-emitting module 60 according to the present embodiment is explained as follows. Light emitted by the light-emitting plate 11 is converged after passing through the anti-peeping film 31. When the light-emitting module 60 in the region in which the third electrode 5222 is located is in the anti-peeping state, and the light-emitting module 60 in the region in which the third electrode 5221 is located is in the sharing state, an ordered electric field is formed between the fifth electrode 6221 and the sixth electrode 6241, the second light-adjusting film 62 in the region in which the fifth electrode 6221 is located is in the transparent state, there is no electric field between the third electrode 5221 and the fourth electrode 5241, and the first light-adjusting film 52 in the region in which the third electrode 5221 is located is in the fog state. There is no electric field between the fifth electrode 6222 and the sixth electrode 6242, the second light-adjusting film 62 in the region where the fifth electrode 6222 is located is in the fog state, an ordered electric field is formed between the third electrode 5222 and the fourth electrode 5242, and the first light-adjusting film 52 in the region where the third electrode 5222 is located is in the transparent state, as shown in (b) of FIG. 12. When the light-emitting module 60 in the region in which the third electrode 5221 is located is in the anti-peeping state, and the light-emitting module 60 in the region in which the third electrode 5222 is located is in the sharing state, the operation principle of the light-emitting module 60 is contrary, as shown in (a) of FIG. 12. Thus, the light rays M1/M1′/M2/M2′ emitted by the light-emitting plate 11 pass through the same medium and keep the same state in the two regions. Compared with Example 5, the uniformity of the color points and the brightness of the light-emitting module 60 is improved. In addition, it is not necessary to adjust the light-emitting plate 11, and the brightness of the light-emitting module 60 may be adjusted only by the first light-adjusting film 52 and the second light-adjusting film 62, thereby improving the adjustment and control capability for the brightness of the light-emitting module 60.

An embodiment of the present application further provides a display device including the light-emitting module described in the embodiment of the present application.

When the display device is a liquid crystal display device, the liquid crystal display device includes a liquid crystal display panel, and any one of the light-emitting module 10, the light-emitting module 20, the light-emitting module 30, the light-emitting module 40, the light-emitting module 50, and the light-emitting module 60 as described above. The light-emitting plate 11 in the light-emitting module may be a conventional edge-lit type light-emitting plate, a direct-type micro light-emitting diode (referred briefly to as MLED) light-emitting plate, or the like.

When the display device is a MLED display device, the MLED display device includes any one of the light-emitting module 10, the light-emitting module 30, the light-emitting module 50, and the light-emitting module 60 as described above. And, the light-emitting plate 11 in the light-emitting module is the direct-type MLED light-emitting plate.

In summary, an embodiment of the present application provides a light-emitting module and a display device, in which a light-adjusting cell or a driving electrode in a light-adjusting film in the light-emitting module is arranged at a partition interval, so that the light-emitting module is compatible with the integral light emitting and the partial anti-peep.

The principles and the embodiments of the present application have been described with reference to specific examples, the description of which is merely intended to aid in the understanding of the method of the present application and the core idea thereof. At the same time, variations will occur to those skilled in the art in both the detailed description and the scope of application in accordance with the teachings of the present application. In view of the foregoing, the present description should not be construed as limiting the application.

1. A light-emitting module comprising a light-emitting plate and a first light-adjusting plate, the first light-adjusting plate being located on a light-exiting side of the light-emitting plate; wherein the first light-adjusting plate comprises:
a first polymer liquid crystal layer comprising polymer networks and liquid crystal molecules dispersed in the polymer networks; and
a first electrode layer and a second electrode layer disposed oppositely on two sides of the first polymer liquid crystal layer, wherein the first electrode layer comprises at least two first electrodes spaced apart.

2. The light-emitting module according to claim 1, wherein the second electrode layer comprises at least two second electrodes spaced apart, the at least two second electrodes and the at least two first electrodes are arranged in one-to-one correspondence, and each of the at least two second electrodes is disposed oppositely to a corresponding one of the at least two first electrodes.

3. The light-emitting module according to claim 1, wherein the first light-adjusting plate further comprises a first polarizer and a second polarizer oppositely disposed, the first polarizer is provided on a side of the first electrode layer facing away from the first polymer liquid crystal layer, and the second polarizer is provided on a side of the second electrode layer facing away from the first polymer liquid crystal layer;
an optical axis direction of the first polarizer is parallel to an optical axis direction of the second polarizer; the polymer networks are extended in a first direction inclined with respect to a normal direction of the first polarizer.

4. The light-emitting module according to claim 3, wherein the first light-adjusting plate further comprises a first alignment layer and a second alignment layer disposed oppositely on the two sides of the first polymer liquid crystal layer, the first alignment layer is disposed between the first electrode layer and the first polymer liquid crystal layer, and the second alignment layer is disposed between the second electrode layer and the first polymer liquid crystal layer; the first alignment layer and the second alignment layer each form an inclined orientation in which a pre-inclined direction is parallel to the first direction.

5. The light-emitting module according to claim 4, wherein the light-emitting module further comprises a light-intensifying plate provided between the light-emitting plate and the first light-adjusting plate, and the light-intensifying plate comprises a sidewise light guide plate and a light-intensifying source located on a side wall of the sidewise light guide plate.

6. (canceled)

7. The light-emitting module according to claim 5, wherein the light-emitting module further comprises an anti-peeping film provided between the light-emitting plate and the first light-adjusting plate, and the light-intensifying plate is provided between the anti-peeping film and the first light-adjusting plate.

8. The light-emitting module according to claim 7, wherein an anti-peeping angle of the anti-peeping film is from 40 degrees to 60 degrees.

9. The light-emitting module according to claim 1, wherein the light-emitting module further comprises an anti-peeping film provided between the light-emitting plate and the first light-adjusting plate.

10. The light-emitting module according to claim 9, wherein the light-emitting module further comprises a second light-adjusting plate located between the light-emitting plate and the anti-peeping film; the second light-adjusting plate comprises:
a second polymer liquid crystal layer comprising polymer networks and liquid crystal molecules dispersed in the polymer networks; and
a third electrode layer and a fourth electrode layer disposed oppositely on two sides of the second polymer liquid crystal layer, the third electrode layer comprises at least two third electrodes spaced apart; and the at least two third electrodes and the at least two first electrodes are arranged in one-to-one correspondence.

11. The light-emitting module according to claim 10, wherein the fourth electrode layer comprises at least two fourth electrodes spaced apart, the at least two fourth electrodes and the at least two third electrodes are arranged in one-to-one correspondence, and each of the at least two fourth electrodes and a corresponding one of the at least two third electrodes are oppositely disposed.

12. The light-emitting module according to claim 10, wherein the light-emitting module comprises a first region and a second region, the first region corresponds to one of the at least two third electrodes, and the second region corresponds to an other one of the at least two third electrodes; when the first region is in an anti-peeping state and the second region is in a sharing state, the first light-adjusting plate in the first region is in a transparent state, the second light-adjusting plate in the first region is in a fog state, the first light-adjusting plate in the second region is in the fog state, and the second light-adjusting plate in the second region is in the transparent state.

13. The light-emitting module according to claim 9, wherein the anti-peeping film and the first light-adjusting plate are adhered by a first optical adhesive layer having a refractive index lower than a refractive index of the first light-adjusting plate.

14. The light-emitting module according to claim 13, wherein the refractive index of the first optical adhesive layer is less than 1.2.

15. A display device comprising a light-emitting module comprising a light-emitting plate and a first light light-adjusting plate, the first light light-adjusting plate being located on a light-exiting side of the light-emitting plate; wherein the first light-adjusting plate comprises:
a first polymer liquid crystal layer comprising polymer networks and liquid crystal molecules dispersed in the polymer networks; and
a first electrode layer and a second electrode layer disposed oppositely on two sides of the first polymer liquid crystal layer, wherein the first electrode layer comprises at least two first electrodes spaced apart.

16. The display device according to claim 15, wherein the second electrode layer comprises at least two second electrodes spaced apart, the at least two second electrodes and the at least two first electrodes are arranged in one-to-one correspondence, and each of the at least two second electrodes is disposed oppositely to a corresponding one of the at least two first electrodes.

17. The display device according to claim 15, wherein the first light-adjusting plate further comprises a first polarizer and a second polarizer oppositely disposed, the first polarizer is provided on a side of the first electrode layer facing away from the first polymer liquid crystal layer, and the second polarizer is provided on a side of the second electrode layer facing away from the first polymer liquid crystal layer;
an optical axis direction of the first polarizer is parallel to an optical axis direction of the second polarizer; the polymer networks are extended in a first direction inclined with respect to a normal direction of the first polarizer.

18. The display device according to claim 17, wherein the first light-adjusting plate further comprises a first alignment layer and a second alignment layer disposed oppositely on the two sides of the first polymer liquid crystal layer, the first alignment layer is disposed between the first electrode layer and the first polymer liquid crystal layer, and the second alignment layer is disposed between the second electrode layer and the first polymer liquid crystal layer; the first alignment layer and the second alignment layer each form an inclined orientation in which a pre-inclined direction is parallel to the first direction.

19. The display device according to claim 18, wherein the light-emitting module further comprises a light-intensifying plate provided between the light-emitting plate and the first light-adjusting plate, and the light-intensifying plate comprises a sidewise light guide plate and a light-intensifying source located on a side wall of the sidewise light guide plate.

20. The display device according to claim 19, wherein the light-emitting module further comprises an anti-peeping film provided between the light-emitting plate and the first light-adjusting plate, and the light-intensifying plate is provided between the anti-peeping film and the first light-adjusting plate.
